(19) United States
(12) Patent Application Publication
(10) Pub. No.: US 2008/0032701 A1
(43) Pub. Date: Feb. 7, 2008

(54) HANDPHONE HOLDER

(76) Inventor: Roberto Johann, Taoyuan City (TW)

Correspondence Address: LEONG C LEI, PMB # 1008, 1867 YGNACIO VALLEY ROAD, WALNUT CREEK, CA, 94598, US

(21) Appl. No.: 11/461,453

(22) Filed: Aug. 1, 2006

(51) Int. Cl. H04Q 7/20

(52) U.S. Cl. 455/456.1

(57) ABSTRACT

A handphone holder is disclosed. The holder comprises a main body and a housing having a shape of a pet, characterized in that the main body contains a power source, an actuating section, a sensor section and an anti-theft section, wherein the actuating section is provided with a control unit and an amplification circuit unit and the control unit is linked to the sensor section and the anti-theft section; the housing is positioned at the upper portion of the main body, and includes a handphone seat, antenna, and the lower portion of the handphone seat is a micro swift, at least a limb electromagnetic element and a spring linking rod, a speaker and at least a light emitter.

### BACKGROUND OF THE INVENTION

(a) Technical Field of the Invention

The present invention relates to a multi functional handphone holder, and in particular, to a handphone holder having the shape of a pet and having the function of anti-theft anti-magnetic and odor analytic. The holder can generate sound and light and move the limbs of the pet.

(b) Description of the Prior Art

Conventional electronic pets are generally toys which provide little functional effect or provide no benefit with relation to daily mechanism. Conventional handphone holder is just a device. For, holding a handphone in an upright position to receive best signal reception. Conventional handphone holder does not provide the function of anti-theft and/or anti-magnetism and the shape of the housing does not contribute additional function to the living environment. Accordingly, it is an object of the present invention to provide a multi functional handphone holder which could overcome the above-mentioned drawbacks.

### SUMMARY OF THE INVENTION

The primary purpose of the present invention is to provide a handphone holder comprising a main body and a housing having a shape of a pet, characterized in that the main body contains a power source, an actuating section, a sensor section and an anti-theft section, wherein the actuating section is provided with a control unit and an amplification circuit unit and the control unit is linked to the sensor section and the anti-theft section; the housing is positioned at the upper portion of the main body, and includes a handphone seat, antenna, and the lower portion of the handphone seat is a micro swift, at least a limb electromagnetic element and a spring linking rod, a speaker and at least a light emitter; whereby the sensor section and the anti-theft section are employed to cause a simulation of movement of the pet to produce a sound and light effect.

Still another object of the present invention to provide a handphone holder wherein the sensor section further comprises an odor sensor button, an odor sensor, an IR human body sensor and a filter sensor.

Yet still another object of the present invention to provide a handphone holder wherein the anti-theft section further comprises an anti-theft control unit, an anti-theft control switch, an anti-theft control button, an anti-theft code setting button, a main body micro switch and a handphone seat micro switch.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view of the handphone holder of the present invention.

FIG. 2 is an exploded view of the handphone holder of the present invention.

FIG. 3 is the bottom view of the handphone holder of the present invention.

FIG. 4 is a block diagram of the component of the handphone holder of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

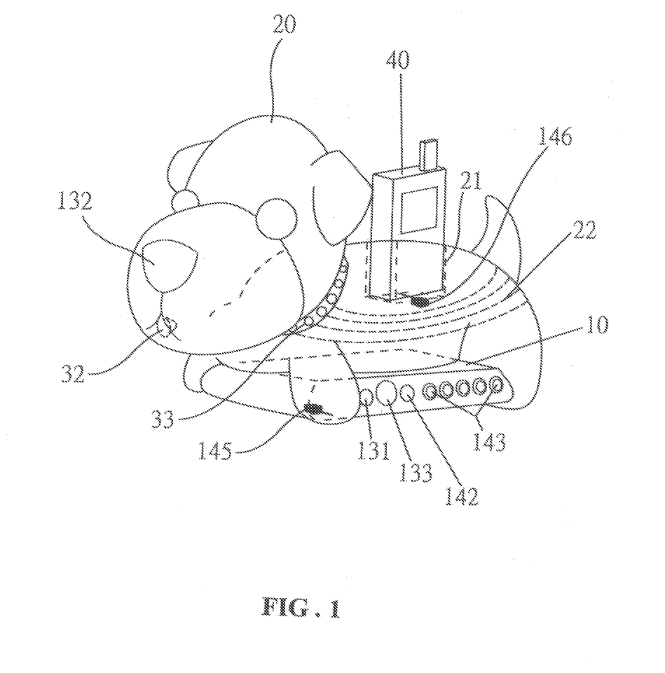

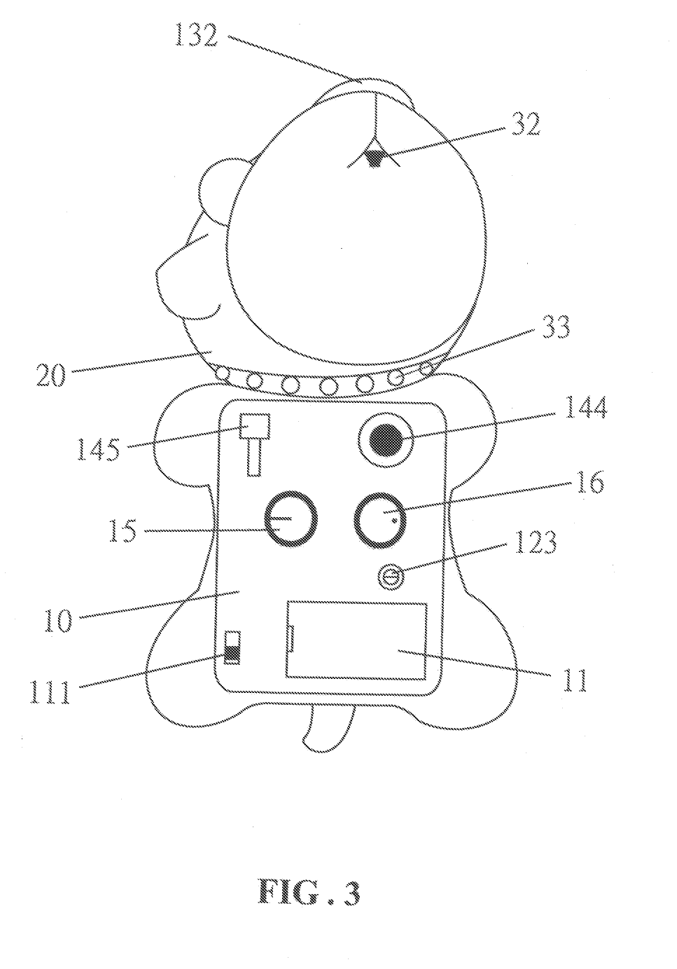

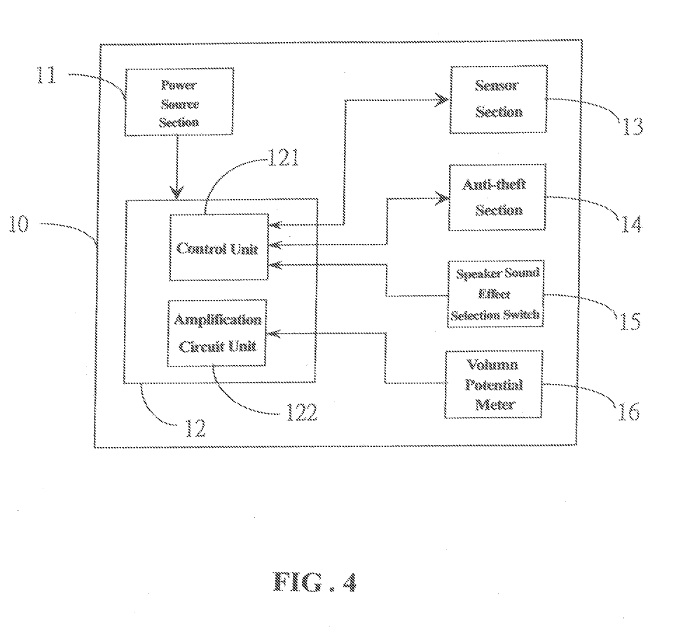

Referring to FIGS. 1, 2, 3 and 4, there is shown a handphone holder having a shape of a pet, which comprises a main body 10 and a pet-shaped housing 20. In accordance with the present invention, the main body 10 contains a power source section 11, including a power source switch 111, and an actuating section 12 including a control unit 121, an amplification circuit unit 122 and a re-set button 123, the control unit 121 linked to a sensor section 13 and an anti-theft section 14; a sensor section 13 containing an odor sensor button 131, an odor sensor 132, an IR human body sensor 133, a filter sensor 134; an anti-theft section 14 including an anti-theft control unit 141, an anti-theft control switch 142, an anti-theft control button 143, an anti-theft code setting button 144, a main body micro switch 145, a handphone seat micro switch 146; a speaker sound effect selection switch 15 linked to the control unit 121 and a volume potential meter 16 linked to the amplification circuit unit 122.

The pet-shaped housing 20 is mounted at the upper section of the main body 10, and the housing 20 is provided with a handphone seat 21, a covered antenna 22, and the lower section of the handphone seat 21 is mounted with a handphone holder micro switch 146, at least a limb electromagnetic element 30 and a spring linked rod 31, a speaker 32 and at lest a light emitter 33. The actuating section 12 of the main body 10 controls the limb electromagnetic element 30, the speaker 32, the light emitter 33. The limb electromagnetic element 30 is an arch-shaped magnet with multiple separation which is mounted at the lateral side of the main body and the lateral side of the limb, which are positioned next to each other. The center of the main body 10 is an aperture allowing the spring linked rod connected to the end of the limb and the end of the body. When the amplification circuit unit is in conduction with the electromagnet, the electromagnet generates a magnetic field such that an attraction and a repulsion movement are formed, causing the limb end to swing from left to right and up and down. This is an action simulating the swinging movement of a pet. The covered antenna 22 is functioned to reduce the magnetic wave of the handphone. The speaker is driven by the actuating section to generate varies types of sound.

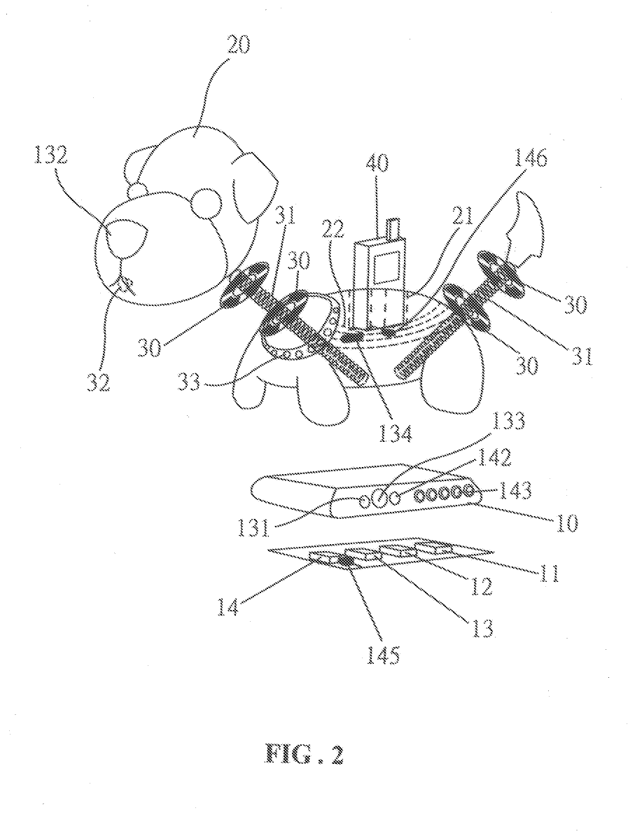

As shown in FIGS. 1 and 2, which shows an implementation of the handphone holder of the present invention. When the IR human body sensor 133 detects an user approaching the housing 20, the actuating section 12 drives the limb electromagnetic element 30, the speaker 32, the light emitter 33 to function, and the pet-shaped housing will generate a head-shaking movement or tail wagging movement, which resembles intimate movement of a pet. When the user places a handphone into the holder seat 21, the micro switch 146 detects the handphone and the anti-theft control unit 141 is triggered. The user has an option to select the holder to activate the anti-theft function. If the anti-theft control switch 142 confirms the setting, the anti-theft control switch 142 cannot be used for switching the anti-theft control button 143 has to be deactivated. If the anti-theft function is activated, and the main body micro switch 145 and the handphone seat micro switch 146 detect an abnormal position of the handphone, the anti-theft control unit 141, via the linked actuating section 12, causes the activation of the limb electromagnetic element 30, the speaker 32, the light emitter 33. The user can press the anti-theft code setting button 144 to operate the anti-theft control button 143 in setting code number. When the handphone 40 receives an in-coming call, the filter sensor 134 will detect the in-coming call to cause the actuating section to drive the limb electromagnetic element 30, the speaker 32, the light emitter 33. When the sensor 13 detects the handphone 40, the actuating section 12 in a pre-set time to trigger the limb electromagnetic element 30, the speaker, the light emitter 33. This is an action to imitate natural reaction of a pet. When the user presses the odor sensor button 131, the actuating section 12 will temporary stop triggering the limb electromagnetic element, the light emitter and speaker. The user blows at the odor sensor 132 at the nose of the pet, the odor is detected and is analyzed, the actuating section will drive the limb electromagnetic element, the light emitter, the speaker with respect to a program setting.

The user could understand the odor from this mouth by way of the odor sensor of the pet-shaped housing.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A handphone holder comprising a main body and a housing having a shape of a pet, characterized in that
the main body contains a power source, an actuating section, a sensor section and an anti-theft section, wherein the actuating section is provided with a control unit and an amplification circuit unit and the control unit is linked to the sensor section and the anti-theft section;
the housing is positioned at the upper portion of the main body, and includes a handphone seat, antenna, and the lower portion of the handphone seat is a micro swift, at least a limb electromagnetic element and a spring linking rod, a speaker and at least a light emitter;
whereby the sensor section and the anti-theft section are employed to cause a simulation of movement of the pet to produce a sound and light effect.

2. The handphone holder of claim 1, wherein the power source further comprises a swift.

3. The handphone holder of claim 1, wherein the actuating section further comprises at reset button.

4. The handphone holder of claim 1, wherein the sensor section further comprises an odor sensor button, an odor sensor, an IR human body sensor and filter sensor.

5. The handphone holder of claim 1, wherein the anti-theft section further comprises an anti-theft control unit, an anti-theft control switch, an anti-theft control button, an anti-theft code setting button, a main body micro switch and a handphone seat micro switch.

6. The handphone holder of claim 1, wherein the control unit is linked to a speaker effect selection switch.

7. The handphone holder of claim 1, wherein the amplification circuit unit is linked to a volume potential meter.

8. The handphone holder of claim 1, wherein the limb electromagnetic element, the speaker, the light emitter are controlled by the actuating section.
